(19) United States
(12) Patent Application Publication
(10) Pub. No.: US 2024/0240649 A1
(43) Pub. Date: Jul. 18, 2024

(54) WIRELESS BUILDING BLOCK TYPE SPLICING FAN

(71) Applicant: HuiZhou Fly Upwards Electron Co.,Ltd., Guangdong (CN)

(72) Inventor: Xinqiang Zhang, Guangdong (CN)

(73) Assignee: HuiZhou Fly Upwards Electron Co.,Ltd., Guangdong (CN)

(21) Appl. No.: 18/344,868

(22) Filed: Jun. 30, 2023

(30) Foreign Application Priority Data
Jan. 14, 2023 (CN) 202320110670.3

(51) Int. Cl. F04D 29/64; F04D 19/00; F04D 29/52; F21S 4/20; F21V 33/00

(52) U.S. Cl. CPC F04D 29/644; F04D 19/002; F04D 29/522; F21S 4/20; F21V 33/0096

(57) ABSTRACT

The present disclosure discloses a wireless building block type splicing fan comprises a fan body. A splicing tenon and a connector plug are disposed on one side of the fan body, and a splicing mortise and a connector socket corresponding to the splicing tenon and the connector plug each other are disposed on the other side of the fan body. A positioning buckle is disposed in the splicing mortise. According to the wireless building block type splicing fan of the present disclosure, when a plurality of fan bodies are spliced, the splicing tenon of one of the two adjacent fan bodies is inserted into the splicing mortise of the other of is the two adjacent fan bodies. After being inserted, the positioning buckle limits and secures the splicing tenon, and at the same time, the connector plug is inserted into the connector socket for electrical connection.

### CROSS-REFERENCE TO RELATED APPLICATION

This application claims the priority benefit of China application Ser. No. 202320110670.3, filed on Jan. 14, 2023. The entirety of the above-mentioned patent application is hereby incorporated by reference herein and made a part of this specification.

### BACKGROUND

### Technical Field

The present disclosure relates to the field of cooling fan, in particular to a wireless building block type fan.

### Description of Related Art

A large number of integrated circuits are used computer components. It is well known, high temperature is the enemy of integrated circuits, because high temperature can not only lead to unstable system operation and shortened service life, but also may even burn out some components. Therefore, heat sinks will be installed in the computer case to the temperature in the chassis to dissipate heat from the inside of the case to achieve the heat dissipation of the computer.

When the existing computer heat sink is working, it is generally through the cooling fan to blow away the heat generated by the integrated circuits. But sometimes by a single cooling fan, the heat dissipation effect achieved is not ideal. Hence there is a splicing cooling fan on the market, but such splicing cooling fan generally using magnetic splicing for splicing, as described for example, Chinese patent: 202121852034.5. However, after the fans are spliced, the splicing firmness is insufficient, and may become loose during operation. In addition, multiple cooling fans may have a lot of wires exposed during splicing, resulting in the cooling fan cannot be easily arranged after splicing. Therefore, such splicing cooling fans need to be improved.

### SUMMARY

The purpose of the present disclosure is to provide a wireless building block type splicing fan that is firmly spliced and convenient to arrange.

In order to solve the above technical problems, the technical solutions taken by the present disclosure are as followings.

A wireless building block type splicing fan comprises a fan body. A splicing tenon and a connector plug are disposed on one side of the fan body, and a splicing mortise and a connector socket corresponding to the splicing tenon and the connector plug each other are disposed on the other side of the fan body. A positioning buckle is disposed in the splicing mortise.

When a plurality of fan bodies are spliced, the splicing tenon of one of the two adjacent fan bodies is inserted into the splicing mortise of the other of cannot the two adjacent fan bodies, and the splicing tenon is limited by the positioning buckle, and the connector plug is inserted into the connector socket for electrical connection.

In one of the embodiments, the wireless building block type splicing fan further comprises a junction box, and a splicing mortise and a connector socket are also disposed on one side of the junction box; during splicing, the splicing tenon of the fan body is inserted into the splicing mortise of the junction box, and the connector plug of the fan body is inserted into the connector socket of the junction box for electrical connection.

In one of the embodiments, the splicing mortise comprises a splicing port and a splicing fixing portion, and the positioning buckle is located at the splicing port; during splicing, the splicing tenon is inserted into the splicing port and is pushed in towards the splicing fixing portion.

In one of the embodiments, the splicing tenon is dovetail-shaped.

In one of the embodiments, the fan body comprises a fan frame and fan blades which are disposed at the fan frame in a rotatable manner, and the fan frame is also provided with a PCB light strip.

In one of the embodiments, shock pads are disposed at corner positions on a front and a back of the fan frame.

In one of the embodiments, magnets are also disposed at the corner positions on the back of the fan frame, and are stacked with shock pads.

In one of the embodiments, double-layer blades are used for the fan blades.

According to the wireless building block type splicing fan of the present disclosure, when a plurality of fan bodies are spliced, the splicing tenon of one of the two adjacent fan bodies is inserted into the splicing mortise of the other of is the two adjacent fan bodies. After being inserted, the positioning buckle can limit and secure the splicing tenon, and at the same time, the connector plug is inserted into the connector socket for electrical connection. Finally, wireless splicing of a plurality of fan body is achieved, so that the spliced fan body is convenient to be arranged during installation. In addition, the splicing tenon is limited and secured by the positioning buckle, so that the fan body is firmer after splicing to avoid loosening.

### BRIEF DESCRIPTION OF THE DRAWINGS

FIG. 1 is a schematic diagram I of the structure according to the wireless building block type splicing fan of the present disclosure;

FIG. 2 is a schematic diagram II of the structure according to the wireless building block type splicing fan of the present disclosure;

FIG. 3 is a spliced state diagram according to the wireless building block type splicing fan of the present disclosure;

FIG. 4 is a spliced state section view according to the wireless building block type splicing fan of the present disclosure;

FIG. 5 is a schematic diagram of the structure of a junction box according to the wireless building block type splicing fan of the present disclosure.

### DESCRIPTION OF THE EMBODIMENTS

In order to make the above purpose, features and advantages of the present disclosure more obvious and easier to understand, the specific embodiments of the present disclosure will be described in detail in the following in conjunction with the accompanying drawings. In the following description, many specific details are elaborated in order to fully understand the present disclosure. However, the present disclosure may be implemented in many other ways different from those described herein, and those skilled in the art may make similar improvements without violating the content of the present disclosure, so the present disclosure is not limited by the specific embodiments disclosed below.

It should be noted that when a component is said to be “fixed” to another component, it can be directly on top of another component or other components can exist in between. When a component is considered to be “connected” to another component, it can be directly connected to another component or other components can exist in between at the same time. Conversely, when a component is described as “directly on” another component, there is no intermediate component. The terms “vertical”, “horizontal”, “left”, “right” and similar expressions used herein are for illustrative purposes only.

Unless otherwise defined, all technical and scientific terms used herein have the same meaning as those normally understood by those skilled in the technical art of the present disclosure. The terms used in the specification of the present disclosure herein are only for the purpose of describing specific embodiments, and are not intended to limit the present disclosure. As used herein, the terms “and/or” include any and all combinations of one or more related items listed.

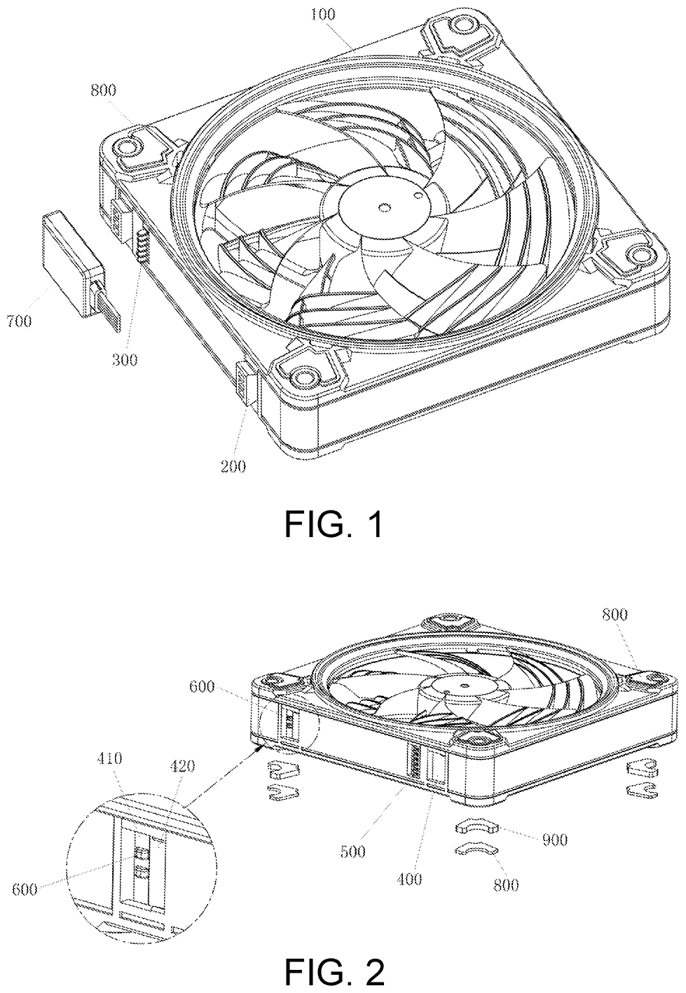

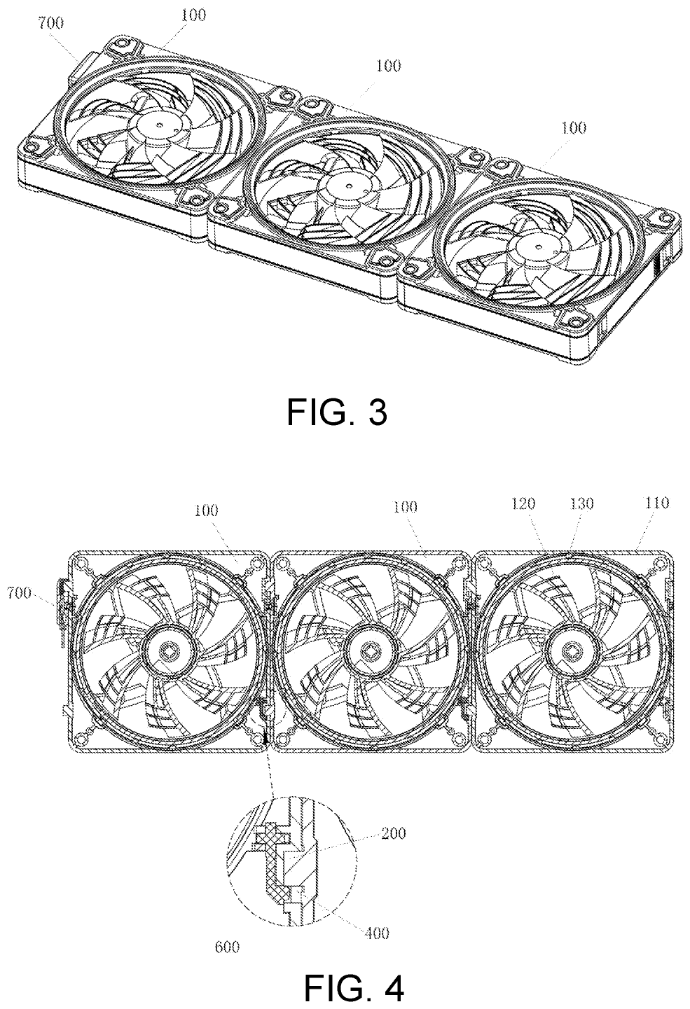

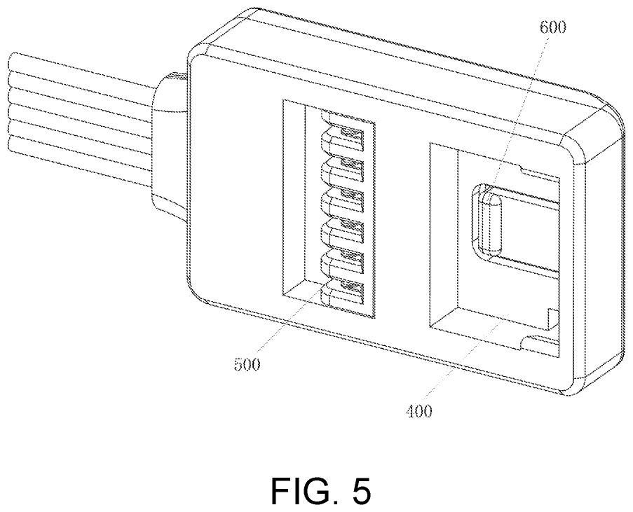

Referring to FIGS. 1 to 5, a wireless building block type splicing fan comprises a fan body 100. A splicing tenon 200 and a connector plug 300 are disposed on one side of the fan body 100, and a splicing mortise 400 and a connector socket 500 corresponding to the splicing tenon 200 and the connector plug 300 each other are disposed on the other side of the fan body 100. A positioning buckle 600 is disposed in the splicing mortise 400.

Specifically, in the present embodiment, the connector plug 300 is disposed on one side of the fan body 100, and the corresponding connector socket 500 is disposed on the other side, so that the connecting wire can be arranged inside the fan body 100. When a plurality of fan bodies 100 is spliced, the splicing tenon 200 of one of the two adjacent fan bodies 100 can be inserted into the splicing mortise 400 of the other of plugs the two adjacent fan bodies 100. After the splicing tenon 200 is inserted into place, the positioning buckle 600 can limit and secure the splicing tenon 200, and at the same time, the connector plug 300 can be inserted into the connector socket 500 for electrical connection, so that there is no wire exposed between the two adjacent fan bodies 100. Finally, wireless splicing of a plurality of fan body 100 is achieved, so that the spliced fan body 100 is easy to be arranged during installation. In addition, the splicing tenon 200 is limited and secured by the positioning buckle 600, so that the fan body 100 is firmer after splicing to avoid loosening.

Of course, in order to make the connection firmer after the splicing tenon 200 being inserted into the splicing mortise 400, the splicing tenon 200 in the present embodiment is dovetail-shaped. Using the dovetail-shaped splicing tenon 200, the connection between the splicing tenon 200 and the splicing mortise 400 is firmer, so that the fan body 100 is more stable and firmer after splicing.

Furthermore, in order to power the spliced fan body 100, the wireless building block type splicing fan in the present embodiment further comprises a junction box 700, and a splicing mortise 400 and a connector socket 500 are also disposed on one side of the junction box 700.

Similarly, when splicing the fan body 100 and the junction box 700, the splicing tenon 200 of the fan body 100 is inserted into the splicing mortise 400 of the junction box 700, so as to realize the splicing between the junction box 700 and the fan body 100. After the splicing tenon 200 is inserted, the positioning buckle 600 can limit and block the splicing tenon 200, so that the splicing between the junction box 700 and the fan body 100 is firmer. At the same time, the connector plug 300 of the fan body 100 can be inserted into the connector socket 500 of the junction box 700, thereby realizing the electrical connection between the junction box 700 and the fan body 100, so that the spliced fan body 100 is powered by the junction box 700 and the fan body 100 can operate normally.

Referring to FIGS. 2 and 4, in the present embodiment in order to facilitate the insertion of the splicing tenon 200 into the splicing mortise 400, the splicing mortise 400 includes a splicing port 410 and a splicing fixing portion 420, and the positioning buckle 600 is located at the splicing port 410.

When splicing the fan body 100, the splicing tenon 200 is inserted into the port 410 of the splicing mortise 400, and the positioning buckle 600 is extruded, after extrusion, then the splicing tenon 200 is pushed in towards the splicing fixing portion 420 of the splicing mortise 400. When pushed into place, the splicing tenon 200 is separated from the positioning buckle 600, and at this time, the positioning buckle 600 reset and pop up, just to get stuck on a side of the splicing tenon 200, so as to limit and secure the splicing tenon 200. Thereby, the splicing tenon 200 is easy to be inserted into the splicing mortise 400, and the connection is firmer after insertion.

Refer to FIG. 4, in order to enable the fan body 100 to operate normally to achieve heat dissipation function, the fan body 100 includes a fan frame 110 and fan blades 120, wherein the fan blades 120 are disposed at the fan frame 110, and can be rotated, so as to achieve heat dissipation. The fan frame 110 is also provided with a PCB light strip 130. The PCB light strip 130 emits light, so that the fan body 100 has a lighting effect, which makes the fan body 100 more distinctive.

Of course, in order to better improve the heat dissipation effect of the fan body 100, double-layer blades are used for the fan blades 120 in the present embodiment, and the heat dissipation effect of the fan body 100 can be improved by double-layer blades.

Please refer to FIG. 1 and FIG. 2. The fan body 100 produces vibration in certain extent during normal operation, therefore in order to avoid the noise caused by vibration, shock pads 800 are disposed at the corner positions of the front and back of the fan frame 110. The use of shock pads 800 provides effective shock suspension, which reduces noise.

Finally, please refer to FIG. 2. In order to facilitate the installation of the fan body 100 into a case, magnets 900 are also disposed at the corner positions on the back of the fan frame 110, and each magnet 900 is stacked with each shock pad 800. When installing the fan body 100, the fan body 100 is first magnetically attracted to the corresponding position of the case through the magnets 900, and then the fan body 100 can be locked by screws, which allows the fan body 100 to be easily installed into the case.

The above shows and describes the basic principles and main features of the present disclosure and the advantages of the present disclosure. All technicians in the art may smoothly implement the utility model as shown in the drawings attached to the specification and as described above. However, all technical personnel familiar with the present specialty, without departing from the scope of the technical solution of the present utility model, using the technical content disclosed above to make some changes, modifications and equivalent changes in evolution, are equivalent embodiments of the present utility model. At the same time, any equivalent changes, modifications and evolution of the above embodiments made according to the substantive technology of the present utility model are still within the scope of protection of the technical solution of the present utility model.

What is claimed is:

1. A wireless building block type splicing fan, comprising:
a fan body;
a splicing tenon and a connector plug disposed on one side of the fan body;
a splicing mortise and a connector socket corresponding to the splicing tenon and the connector plug respectively disposed on the other side of the fan body; and
a positioning buckle disposed in the splicing mortise,
wherein, when a plurality of fan bodies are spliced, the splicing tenon of one of the two adjacent fan bodies is inserted into the splicing mortise of the other of firmer the two adjacent fan bodies, and the splicing tenon is limited by the positioning buckle, and the connector plug is inserted into the connector socket for electrical connection.

2. The wireless building block type splicing fan according to claim 1, wherein the fan further comprises a junction box, and a splicing mortise and a connector socket are also disposed on one side of the junction box;
during splicing, the splicing tenon of the fan body is inserted into the splicing mortise of the junction box, and the connector plug of the fan body is inserted into the connector socket of the junction box for electrical connection.

3. The wireless building block type splicing fan according to claim 1, wherein the splicing mortise comprises a splicing port and a splicing fixing portion, and the positioning buckle is located at the splicing port;
during splicing, the splicing tenon is inserted into the splicing port and is pushed in towards the splicing fixing portion.

4. The wireless building block type splicing fan according to claim 3, wherein the splicing tenon is dovetail-shaped.

5. The wireless building block type splicing fan according to claim 1, wherein the fan body comprises a fan frame and fan blades which are disposed at the fan frame in a rotatable manner, and the fan frame is also provided with a PCB light strip.

6. The wireless building block type splicing fan according to claim 5, wherein shock pads are disposed at corner positions on a front and a back of the fan frame.

7. The wireless building block type splicing fan according to claim 6, wherein magnets are also disposed at the corner positions on the back of the fan frame, and each magnet is stacked with each shock pad.

8. The wireless building block type splicing fan according to claim 5, wherein double-layer blades are used for the fan blades.
